(19) United States
(12) Patent Application Publication
(10) Pub. No.: US 2021/0111601 A1
(43) Pub. Date: Apr. 15, 2021

(54) Rotor for a Brushless Direct-Current Motor, Particularly for an Electric Motor of the Inner Rotor Type, and Electric Motor Comprising Such a Rotor

(71) Applicant: Robert Bosch GmbH, Stuttgart (DE)

(72) Inventors: Patrick Budaker, Weinstadt (DE); Joachim Heizmann, Immendingen (DE); Michael Palsule Desai, Stuttgart (DE)

(21) Appl. No.: 16/603,290

(22) PCT Filed: Mar. 1, 2018
(86) PCT No.: PCT/EP2018/055019

§ 371 Date: Oct. 7, 2019

(30) Foreign Application Priority Data
Apr. 7, 2017 (DE) 10 2017 205 950.8
Jan. 4, 2018 (DE) 10 2018 200 077.8

(51) Int. Cl. H02K 1/27; H02K 1/02; H02K 7/14; H02K 21/16

(52) U.S. Cl. CPC H02K 1/2733; H02K 1/02; H02K 2213/03; H02K 21/16; H02K 7/145

(57) ABSTRACT

The disclosure relates to a rotor for a brushless direct-current motor comprising a shaft, a rotor core arranged on the shaft, the rotor core acting as a return body, and a ring magnet which surrounds the rotor core and is attached to same. The ring magnet is in the form of a circular disk, a radial direction and a peripheral direction being defined by the circular disk. Furthermore, a hole count q is defined by the equation q=N/(2 pm), N being the number of grooves in the rotor, p being the number of pole pairs of the rotor, and m being the number of phases. According to the disclosure, the winding of the rotor is connected in a delta connection.

### PRIOR ART

The invention relates to a rotor for an electric motor, in particular for an internal-rotor electric motor. The invention further relates to an electric motor comprising a rotor according to the invention.

An electric motor is an energy converter which converts electrical energy into mechanical energy. An electric motor of this kind comprises a stator, which forms the stationary part of the motor, and a rotor, which forms the moving part of the motor. In the case of an internal-rotor motor, the circular or cylindrical ring-like rotor generally surrounds the motor shaft on which it is also fastened and, for its part, is in turn surrounded by the stator which is at a distance from the rotor in the radial direction.

The stator is usually provided with a stator yoke on which stator teeth which protrude inward radially to the center are arranged, the ends of said stator teeth which face the rotor forming the so-called pole shoe. In order to ensure the functioning of an electric motor, the coils which are associated with the stator of the motor have to be connected to one another in a specific manner, amongst other things. The manner of this interconnection is defined by windings which are fitted onto the stator teeth and generate a magnetic field during electromotive operation. In order to guide and intensify the magnetic field which is generated by the energized windings, the stator material is usually metallic, for example soft-magnetic iron.

In this case, the winding scheme can describe, for example, a star connection of the coils or a delta connection of the coils. If a large number of coils which are to be connected to one another belong to the stator, the interconnection is then very complicated since the respective coils have to be connected to one another by individual wires in a specific manner.

However, one disadvantage of the design of the rotor with ring magnets is that the ring magnets are mechanically less robust on account of their production method and therefore cannot withstand the centrifugal forces which occur in the case of large rotor radii and/or high revolution speeds without damage. Consequently, the motor powers of electric motors with rotors of this kind are generally comparatively low.

The object of the invention is to improve the abovementioned disadvantages and to specify a rotor for an electric motor, which rotor has a comparatively high magnetic flux and also a low leakage flux at the same time, but is suitable for high rotation speeds at the same time. A further object of the invention is to develop an electric motor and a handheld power tool in a corresponding manner.

### DISCLOSURE OF THE INVENTION

This object is achieved by a rotor as claimed in claim 1 and also by an electric motor as claimed in claim 13 and a handheld power tool as claimed in claim 16. Advantageous refinements, variants and developments of the invention can be found in the dependent claims.

The invention comprises a rotor for a brushless direct-current motor, comprising a shaft, a rotor core which is arranged on the shaft, wherein the rotor core serves as a magnetic return path body, and a ring magnet which is fastened to the rotor core and surrounds the rotor core. The ring magnet is of circular disk-like design, wherein a radial direction and a peripheral direction are defined by the circular disk shape. Furthermore, a number q of holes is defined by the equation q=N/(2 pm), wherein N represents the number of slots in the rotor, p represents a number of pole pairs of the rotor, and m represents a number of phases. The invention makes provision for the winding of the rotor to be connected in delta. In principle, the delta connection has proven advantageous in respect of production since it generally requires smaller wire diameters than the star connection in the case of brushless direct-current motors with a small number of turns and large wire diameters (for example in battery-operated handheld power tools). is the Delta connection advantageous in respect of production.

A rotor winding preferably has a number q of holes of q=0.5, wherein the waveform of a source voltage of the electric motor is matched to the current waveform. Matching the waveform of the source voltage to the current waveform (both virtually trapezoidal) results in a higher machine utilization and a more uniform torque profile.

In this case, it is advantageous for the waveform of the source voltage to have a virtually trapezoidal or a virtually sinusoidal profile, wherein a particularly expedient virtually trapezoidal waveform of the induced the source voltage from phase to phase can be achieved by the combination of number of holes q=0.5 (e.g.: 9-slot/6-pole) and delta connection of the winding.

Rotor as claimed in one of claims 1 to 5, characterized in that the electric motor is used a block commutation of 120°. It has been found to be advantageous for the trapezoidal shape of the source voltage with 120° block commutation of the electric current to be able to achieve the greatest possible machine utilization and, respectively, the greatest possible power factor of this machine, wherein smaller wire diameters with a lower wire tension advantageously also permit compact and efficient needle winding.

In a particularly preferred embodiment, the ring magnet has a radially anisotropic grain structure. In principle, ring magnets provide, in comparison, a higher total magnetic flux due to the larger pole width and the lower flux leakage. Owing to a rotor according to the invention, the magnetic remanence flux density can be increased, as a result of which, in comparison, the active axial length of the motor and/or the electrical resistance can be reduced and the power density of the electric motor can be increased in turn.

The ring magnet is preferably an NdFeB ring magnet which is magnetized at several poles over the outer periphery.

In a particularly preferred embodiment, the ring magnet has at least three pole pairs, preferably at least 8 pole pairs, particularly preferably at least 18 pole pairs.

The ring magnet is advantageously a sintered rare-earth magnet composed of SmCo powder, a sintered ferrite magnet composed of NdFeB powder, a hot-pressed/hot-deformed magnet or a bonded magnet, wherein the radially anisotropic grain structure is produced by a two-stage compaction process. The radially oriented anisotropic injection-molded ring magnets are usually produced by electromagnetic orientation technology. In contrast to the simple permanent magnet orientation, magnets which are produced by electromagnetic orientation are demagnetized before the lowering, and then polarized in line with the desired requirements.

An increased mechanical load-bearing capacity and, respectively, robustness of the ring magnet can be ensured by producing the ring magnet by hot-pressing the NdFeB powder. In addition, the radial anisotropy of the grain structure of the ring magnet, which radial anisotropy is introduced in a separate production step, leads to a remanence flux density which is once again increased by approximately 10% in comparison to conventionally sintered ring magnets and therefore to an increased power density.

As an alternative, the production of the ring magnet can also be produced in accordance with another process, for example in accordance with the impact extrusion process.

In one advantageous refinement, the ring magnet is fastened to the rotor core using one of the fastening processes from the group comprising adhesive bonding, soldering, thermal shrink-fitting, welding.

Furthermore, the geometry and topology of the stator and also the number of pole pairs of the ring magnet can vary depending on the design. A radially anisotropic ring magnet according to the invention is not subject to any restrictions in this respect.

A further subject matter of the present invention is formed by an electric motor, preferably a brushless internal-rotor electric motor. The electric motor comprises a stator and a rotor. The stator has a circular disk-like stator yoke, by way of which a radial direction and a peripheral direction are defined, and also a defined number of pole teeth which project radially inward from the stator yoke. The rotor is enclosed by the stator in the radial direction. A gap with a defined width is arranged between the stator and the rotor. The electric motor further comprises a number of coils which corresponds to the number of pole teeth, wherein the coils are wound around the corresponding pole teeth. The invention makes provision for the rotor to be designed as claimed in one of the embodiments disclosed in claims 1 to 12 and mentioned above.

The electric motor advantageously has an idling rotation speed of at least 24,000 revolutions per minute and a rotor diameter of the rotor of 30 mm.

In a preferred embodiment, the coils of the electric motor are connected electrically in parallel.

A further subject matter of the present invention is formed by a handheld power tool which comprises an electric motor according to the invention as claimed in one of claims 13 to 15.

Further features, application possibilities, advantages and refinements of the invention can be found in the following description of the exemplary embodiments of the invention which are illustrated in the figures. The description, the associated figures and the claims contain numerous features in combination. A person skilled in the art will also consider these features, in particular also the features of various exemplary embodiments, individually and combine them to form appropriate further combinations. It should be noted in this regard that the illustrated features are merely descriptive in character and may also be used in combination with features of other further developments described above, and are not intended to limit the invention in any way.

### DRAWINGS

The invention will be explained in more detail below with reference to preferred exemplary embodiments. In the drawings, in each case in schematic form:

FIG. 1 shows a detail of a rotor according to the invention and also of an electric motor according to the invention;

FIG. 2 shows an example of a delta connection with a parallel individual tooth winding;

FIG. 3 shows an example of an adapted waveform of an induced source voltage; and

FIG. 4 shows a schematic illustration of a ring magnet with a radially isotropic orientation of the preferred magnetic direction.

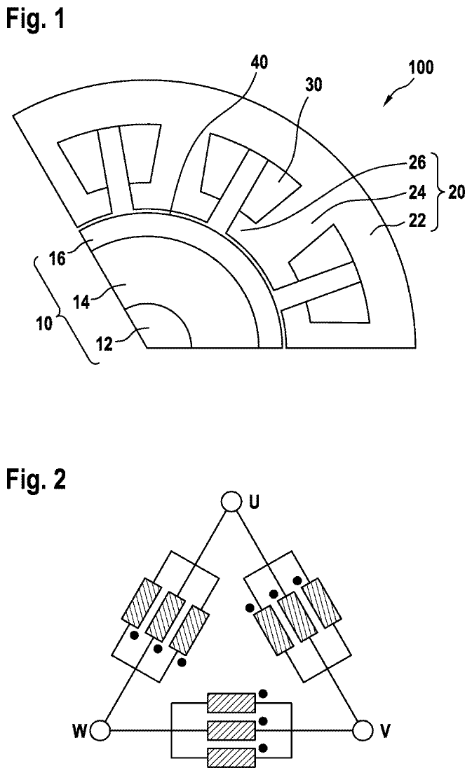

FIG. 1 shows a 120° segment of a partial cross section of an electric motor 100 according to the invention. The rotor of the electric motor 100 comprises, amongst other things, a shaft 12, a rotor core 14 which is arranged on the shaft 12, wherein the rotor core 14 serves as a magnetic return path body. The electric motor 100 further comprises at least one ring magnet 16 which is fastened to the rotor core 14 and surrounds the rotor core 14. The ring magnet 16 is of circular annular disk-like the cylindrical ring-like design, wherein a radial direction and a peripheral direction are defined by the circular disk shape and, respectively, the cylindrical ring shape.

The at least one ring magnet 16 is fastened to the rotor core 14 using one of the fastening processes from the group comprising adhesive bonding, soldering, thermal shrink-fitting or welding.

It can further be seen that the electric motor 100 comprises a stator 20, wherein the stator 20 has a circular disk-like stator yoke 22, by way of which a radial direction and a peripheral direction are defined, and also a defined number of pole teeth 24 which project radially inward from the stator yoke 22. A corresponding number of coils 30 are wound around the pole teeth 24. This basic construction is known per se in the case of internal-rotor electric motors and will not be described in further detail.

According to the invention, the ring magnet 16 has a radially anisotropic grain structure. In one embodiment, in which the ring magnet 16 is a ring magnet 16 which is hot-pressed from NdFeB powder, this radial anisotropy can be achieved in a compaction step which follows the first hot-pressing operation, therefore by a two-stage compaction process.

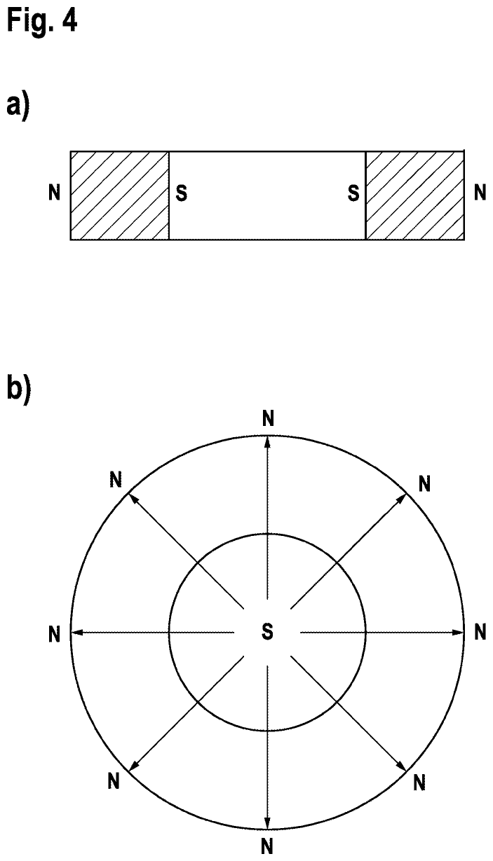

As an alternative to this and according to a further embodiment of the invention, the ring magnet 16 can be a sintered ring magnet 16 composed of SmCo powder or of NdFeB powder, wherein the radially anisotropic grain structure is likewise produced by a two-stage compaction process. The radially oriented anisotropic injection-molded ring magnets are usually produced by electromagnetic orientation technology. In contrast to the simple permanent magnet orientation, magnets which are produced by electromagnetic orientation are demagnetized before the lowering, and then polarized in line with the desired requirements. In this way, for example, a ring magnet 16, illustrated in FIG. 4, with a radially isotropic orientation of the preferred magnetic direction can be produced.

An increased mechanical load-bearing capacity and, respectively, robustness of the ring magnet can be ensured by producing the ring magnet 16 by hot-pressing the NdFeB powder. In addition, the radial anisotropy of the grain structure of the ring magnet 16 which is introduced in a separate production step leads to a remanence flux density which is once again increased by approximately 10% in comparison to conventionally sintered ring magnets 16 and therefore to an increased power density. As an alternative, the production of the ring magnet 16 can also be produced in accordance with another process, for example in accordance with the impact extrusion process.

The anisotropy improves the magnetic remanence flux density by up to 10% in comparison to conventional sintered NdFeB magnets and by the factor 2.2 in comparison to the conventional plastic-bonded NdFeB magnets. Owing to this gain in magnetic flux across the ring magnet 16, the active axial length of the electric motor 100 and/or its electrical resistance can be reduced. According to the invention, the power density of the electric motor 100 and at the same time its mechanical robustness can be increased in this way. As a result, high rotation speeds are possible even in the case of large rotor diameters.

For example, it has been shown that an electric motor 100 which is constructed according to the invention can travel at a rotation speed of over 24,000 rpm during idling given a rotor diameter of 30 mm. Comparable values are currently provided in the prior art only by rotors with buried magnets, but with the abovementioned disadvantages which accompany this construction.

In a preferred embodiment, the ring magnet 16 has at least three pole pairs, preferably at least 8 pole pairs, particularly preferably at least 18 pole pairs. In general, the number of pole pairs of the ring magnet varies depending on the design in respect of size and power of the electric motor, wherein a radially anisotropic ring magnet is not subject to any restrictions in this respect.

It should once again be noted that, in contrast to this, the design with buried magnets has the disadvantage that the number of magnets and therefore of pole pairs is limited by the width of the webs of the rotor lamination between the magnets.

The higher magnetic flux in a rotor according to the invention also requires larger cross sections in the stator geometry. In this respect, it is advantageous, in principle, for the number of poles in the design according to the invention to not be limited since a higher number of pole pairs reduces the cross section of the iron magnetic return path. This is because the magnetic flux can be distributed between a higher number of pole pairs.

Furthermore, fewer turns are required in the stator for high rotation speeds given a higher magnetic flux. This in turn means that the copper wire cross sections have to increase in order to be able to equally fill the stator slot with fewer turns.

In general, needle winding machines are used here, wherein the needle, which guides the wire through the slots, can guide a wire with a maximum wire diameter of just over 1 mm.

As illustrated in FIG. 2, according to the invention, the winding of the rotor is connected in delta with parallel individual tooth windings, wherein a rotor winding preferably has a number q of holes of q=0.5.

In this case, the number q of holes is defined by the equation q=N/(2 pm), wherein N represents the number of slots in the rotor, p represents a number of pole pairs of the rotor, and m represents a number of phases.

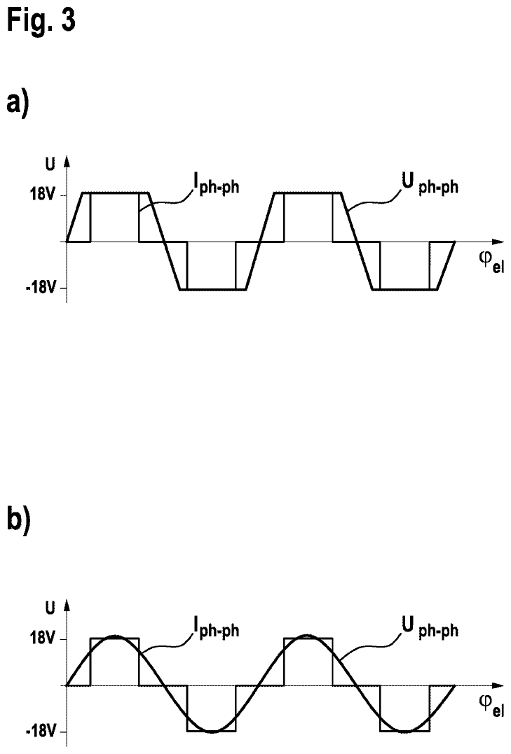

As illustrated in FIG. 3a, a waveform of an induced source voltage, also called electromotive force or induced EMF voltage of the electric motor, is matched to a current waveform. Whereas the current waveform has a typical 120° block commutation in the figure, the induced source voltage is trapezoidal. This results in a high machine utilization and a largely uniform torque profile. In the illustrated configuration of the 120° block commutation, the trapezoidal waveform of the source voltage almost achieves the greatest possible machine utilization and, respectively, the greatest power factor of the electric motor. As illustrated in FIG. 3b, in an alternative embodiment, the induced source voltage is sinusoidal given the same current waveform.

FIG. 4b shows a plan view of the radially isotropic ring magnet 16 with an exemplary illustration of the magnetic preferred direction. The 4a shows a corresponding sectional view.

Further embodiments which can comprise further modifications and also combinations of features are conceivable in addition to the embodiments described and depicted.

1. A rotor for a brushless direct-current motor, the rotor comprising:
a shaft;
a rotor core arranged on the shaft, the rotor core configured as a magnetic return path body; and
at least one ring magnet fastened to the rotor core and configured to surround the rotor core, the at least one ring magnet is having one of a circular disk shape and a cylindrical ring shape, a radial direction and a peripheral direction being defined by the one of the circular disk shape and the cylindrical ring shape,
wherein a number q of holes is defined by the equation q=N/(2 pm), where N represents a number of slots in the rotor, p represents a number of pole pairs of the rotor, and m represents a number of phases, and
wherein a winding of the rotor is connected as a delta connection.

2. The rotor as claimed in claim 1, wherein the winding of the rotor the number q of holes, where q=0.5.

3. The rotor as claimed in claim 1, wherein a waveform of an induced source voltage of the brushless direct-current motor is matched to a current waveform.

4. The rotor as claimed in claim 3, wherein the waveform of the induced source voltage has a trapezoidal profile.

5. The rotor as claimed in claim 3, wherein the waveform of the induced source voltage has a sinusoidal profile.

6. The rotor as claimed in claim 1, wherein the brushless direct-current motor uses a block commutation of 120°.

7. The rotor as claimed in claim 1, wherein the at least one ring magnet has a radially anisotropic grain structure.

8. The rotor as claimed in claim 1, wherein the at least one ring magnet is one of an SmCo ring magnet and NdFeB ring magnet and is magnetized at several poles over an outer periphery thereof.

9. The rotor as claimed in claim 1, wherein the at least one ring magnet has at least three pole pairs.

10. The rotor as claimed in claim 7, wherein the at least one ring magnet is a hot-pressed ring magnet comprised of one of SmCo powder and of NdFeB powder, the radially anisotropic grain structure being produced by a two-stage compaction process.

11. The rotor as claimed in claim 7, wherein the at least one ring magnet is a sintered ring magnet comprised of NdFeB powder, the radially anisotropic grain structure being produced by a two-stage compaction process.

12. The rotor as claimed in claim 1, wherein the at least one ring magnet is fastened to the rotor core using one of adhesive bonding, soldering, thermal shrink-fitting, and welding.

13. An electric motor comprising
a stator having one of a circular disk stator yoke and a cylindrical ring stator yoke, a radial direction and a peripheral direction being defined by the one of the circular disk stator yoke and the cylindrical ring stator yoke, the stator having a defined number of pole teeth that project radially inward from the one of the circular disk stator yoke and the cylindrical ring stator yoke;
a number of coils that corresponds to the defined number of pole teeth, coils of the number of coils being wound around corresponding pole teeth of the defined number of pole teeth; and
a rotor that is enclosed by the stator in the radial direction, a gap having a defined width being defined between the stator and the rotor, the rotor having (i) a shaft, (ii) a rotor core arranged on the shaft, the rotor core configured as a magnetic return path body, and (iii) at least one ring magnet fastened to the rotor core and configured to surround the rotor core, the at least one ring magnet having one of a circular disk shape and a cylindrical ring shape, a number q of holes being defined by the equation q=N/(2 pm), where N represents a number of slots in the rotor, p represents a number of pole pairs of the rotor, and m represents a number of phases, a winding of the rotor being connected as a delta connection.

14. The electric motor as claimed in claim 13, wherein the electric motor has an idling rotation speed of at least 24,000 revolutions per minute and the rotor has a diameter of 30 mm.

15. The electric motor as claimed in claim 13, wherein the number of coils of the electric motor are connected electrically in parallel.

16. A handheld power tool comprising:
an electric motor comprising:
a stator having one of a circular disk stator yoke and a cylindrical ring stator yoke, a radial direction and a peripheral direction being defined by the one of the circular disk stator yoke and the cylindrical ring stator yoke, the stator having a defined number of pole teeth that project radially inward from the one of the circular disk stator yoke and the cylindrical ring stator yoke;
a number of coils that corresponds to the defined number of pole teeth, coils of the number of coil being wound around the corresponding pole teeth of the defined number of pole teeth; and
a rotor that is enclosed by the stator in the radial direction, a gap having a defined width being defined between the stator and the rotor, the rotor having (i) a shaft, (ii) a rotor core arranged on the shaft, the rotor core configured as a magnetic return path body, and (iii) at least one ring magnet fastened to the rotor core and configured to surround the rotor core, the at least one ring magnet having one of a circular disk shape and a cylindrical ring shape, a number q of holes being defined by the equation q=N/(2 pm), where N represents a number of slots in the rotor, p represents a number of pole pairs of the rotor, and m represents a number of phases, a winding of the rotor being connected as a delta connection.

17. The rotor as claimed in claim 9, wherein the at least one ring magnet has at least 8 pole pairs.

18. The rotor as claimed in claim 17, wherein the at least one ring magnet has at least 18 pole pairs.

19. The electric motor as claimed in claim 13, wherein the electric motor is a brushless internal-rotor electric motor.
